(19) United States
(12) Patent Application Publication
(10) Pub. No.: US 2026/0183992 A1
(43) Pub. Date: Jul. 2, 2026

(54) RELEASE FILM AND METHOD OF PRODUCING SEMICONDUCTOR PACKAGE

(71) Applicant: RESONAC CORPORATION, Tokyo (JP)

(72) Inventors: Koji NAKAMURA, Minato-ku, Tokyo (JP); Ryo TAMURA, Minato-ku, Tokyo (JP); Satoshi YABUSHITA, Minato-ku, Tokyo (JP); Tetsuya TANIGUCHI, Minato-ku, Tokyo (JP); Kazunori SAKUMA, Minato-ku, Tokyo (JP)

(73) Assignee: RESONAC CORPORATION, Tokyo (JP)

(21) Appl. No.: 18/861,289

(22) PCT Filed: Jun. 26, 2023
(86) PCT No.: PCT/JP2023/023662

§ 371 Date: Oct. 29, 2024

(30) Foreign Application Priority Data
Jul. 26, 2022 (WO) PCT/JP2022/028841

(51) Int. Cl. B29C 33/68; B32B 3/30; B32B 7/06; B32B 27/08; B32B 27/30

(52) U.S. Cl. CPC B29C 33/68; B32B 3/30; B32B 7/06; B32B 27/08; B32B 27/308

(57) ABSTRACT

A release film includes a release layer and a substrate layer, the release layer includes two or more polymers, and satisfies at least one of the following (1) to (4). (1) The release layer has a plurality of different regions with different component ratios, and in a case in which Raman spectroscopy is performed on the different regions, at least a part of the different regions exhibits different peak intensities. (2) A surface of the release layer has a convex portion and a concave portion, and in a case in which Raman spectroscopy is performed on the convex portion and the concave portion, at least a part of the convex portion and at least a part of the concave portion exhibits different peak intensities. (3) A difference in SP value between at least two of the polymers is 0.3 or more. (4) At least one of the polymers is a nitrile group-containing (meth)acrylic polymer.

### TECHNICAL FIELD

The present disclosure relates to a release film and a method of producing a semiconductor package

### BACKGROUND ART

Semiconductor chips are usually sealed with resin to shield and protect them from the outside air, and are mounted on a substrate as a molded product called a package. The molded product is made by injecting a resin-containing sealing material into a mold. The mold has multiple cavities that are connected via runners that act as flow paths for the sealing material. In order to make it easier to release the molded product from the mold, various improvements have been made, such as the structure of the mold and the addition of a mold release agent to the sealing resin.

On the other hand, due to demands for smaller packages and more pins, packaging methods such as the Ball Grid Array (BGA) method, Quad Flat Non-leaded (QFN) method, and Wafer Level Chip Size Package (WL-CSP) method are becoming more common. In the QFN method, in order to ensure stand-off and prevent burrs from occurring at the terminals due to the sealing material, and in the BGA and WL-CSP methods, in order to improve the releasability of the package from the mold, a resin release film is placed along the inside of the mold, and the sealing material is injected into it for molding (see, for example, Patent Document 1). The molding method using a release film is called the “film-assisted molding method.”

### RELATED ART DOCUMENTS

### Patent Documents

Patent Document 1: Japanese Patent Application Laid-Open (JP-A) No. 2002-158242

### SUMMARY OF INVENTION

In a case in which the above release film is used, flow marks of the sealing material may remain on a surface of the molded package, which may deteriorate an appearance. In order to reduce flow marks, it is possible to add a filler to the release layer of the release film.

In addition, in recent years, a technology has been considered in which multiple packages are mounted on a substrate and then sealed all at once. In this case, since there are packages of various shapes on the substrate, the release film is required to have excellent elongation properties.

When the release film is stretched, the release layer also stretches to follow the stretch of a substrate layer, but the release layer may not be able to follow and break, making it difficult to remove the molded product from the mold or difficult to remove it.

In particular, in release films to which filler has been added to reduce flow marks, an elongation rate of the release layer decreases and the release layer tends to break easily.

In view of the above circumstances, the present disclosure aims to provide a release film that has excellent elongation and can reduce flow marks of a sealing material on a surface of a semiconductor package, and a method of producing a semiconductor package using the release film.

### Solution to Problem

Means for solving the above problems include the following embodiments.
<1> A release film including a release layer and a substrate layer, in which:
   the release layer includes two or more polymers, and
   a difference in SP value between at least two of the polymers is 0.3 or more.
<2> A release film including a release layer and a substrate layer, in which:
   the release layer includes two or more polymers, and
   at least one of the polymers is a nitrile group-containing (meth)acrylic polymer.
<3> A release film including a release layer and a substrate layer, in which:
   the release layer includes two or more polymers, and
   at least one of the following (1) or (2) is satisfied:
   (1) the release layer has a plurality of different regions with different component ratios, and in a case in which Raman spectroscopy is performed on the different regions, at least a part of the different regions exhibit different peak intensities, or
   (2) a surface of the release layer has a convex portion and a concave portion, and in a case in which Raman spectroscopy is performed on the convex portion and the concave portion, at least a part of the convex portion and at least a part of the concave portion exhibit different peak intensities.
<4> The release film according to <2> or <3>, in which a difference in SP value between at least two of the polymers is 0.3 or more.
<5> The release film according to <1> or <3>, in which at least one of the polymers is a nitrile group-containing (meth)acrylic polymer.
<6> The release film according to <1> or <2>, in which at least one of the following (1) or (2) is satisfied.

(1) the release layer has a plurality of different regions with different component ratios, and in a case in which Raman spectroscopy is performed on the different regions, at least a part of the different regions exhibit different peak intensities, or

(2) a surface of the release layer has a convex portion and a concave portion, and in a case in which Raman spectroscopy is performed on the convex portion and the concave portion, at least a part of the convex portion and at least a part of the concave portion exhibit different peak intensities.
<7> The release film according to <3> or <6>, in which a component ratio of the polymers is different in at least a part of the plurality of the different regions, or in at least a portion of the convex portion and at least a portion of the concave portion.
<8: The release film according to <7>, in which a content of a nitrile group-containing (meth)acrylic polymer is different in at least a part of the plurality of different regions, or in at least a part of the convex portion and at least a portion of the concave portion.
<9> The release film according to <3> or <6>, in which at least a part of the convex portion and the concave portion are formed by phase separation within the release layer.
<10> The release film according to <3> or <6>, in which no interface is observed around the convex portion within the release layer under a laser microscope.
<11> The release film according to <3> or <6>, in which peaks exhibiting different peak intensities are peaks derived from nitrile groups.
<12> The release film according to <3> or <6>, in which the surface of the release layer has a convex portion and a concave portion, and a peak intensity derived from a nitrile group in at least a part of the convex portion is greater than a peak intensity derived from a nitrile group in at least a part of the concave portion.
<13> The release film according to <3> or <6>, in which a surface of the release layer has a convex portion and a concave portion, and a content by mass of a nitrile group-containing (meth)acrylic polymer in at least a part of the convex portion is greater than a content by mass of a nitrile group-containing (meth)acrylic polymer in at least a part of the concave portion.
<14> The release film according to any one of <1> to <13>, in which an arithmetic mean roughness (Ra) of an outer surface of the release layer is 1.5 μm or less.
<15> The release film according to any one of <1> to <14>, in which a weight average molecular weight (Mw) of the polymers is 1.0×10⁵ or more.
<16> The release film according to any one of <1> to <15>, in which at least one of the polymers is a polymer containing a structural unit derived from a (meth)acrylonitrile monomer, and a difference in proportion of structural units derived from a (meth)acrylonitrile monomer between at least two of the polymers is 1% by mass or more.
<17> The release film according to any one of <1> to <16>, in which the two or more polymers are (meth)acrylic polymers having a structural unit derived from a (meth)acryloyl monomer.
<18> The release film according to any one of <1> to <17>, in which at least a portion of the polymer is crosslinked.
<19> The release film according to any one of <1> to <18>, in which a content of the polymer with a highest content in the release layer is 95% by mass or less with respect to a total content of the polymers.
<20> The release film according to any one of <1> to <19>, in which the substrate layer is a polyester film.
<21> The release film according to any one of <1> to <20>, in which a thickness of the release layer is from 1 μm to 50 μm.
<22> The release film according to any one of <1> to <21>, which is a release film for a transfer mold or a release film for a compression mold.
<23> A method of producing a semiconductor package, including:
   carrying out a transfer molding process or a compression molding process using the release film according to any one of <1> to <22>.

### Advantageous Effects of Invention

According to the present disclosure, it is possible to provide a release film that has excellent elongation and can reduce flow marks of a sealing material on a surface of a semiconductor package, and a method of producing a semiconductor package using the release film.

### BRIEF DESCRIPTION OF DRAWINGS

FIG. 1 is a schematic cross-sectional view showing the configuration of a release film.

FIG. 2 is a laser microscope photograph and an analysis graph of a surface of a release layer.

FIG. 3 is a spectrum results of component analysis by microscopic Raman spectroscopy of a discontinuous phase (island phase, convex portion) and a continuous phase (sea phase, concave portion) of sample G2 in FIG. 2.

FIG. 4 is a spectrum results of component analysis by microscopic Raman spectroscopy of a discontinuous phase (island phase, concave portion) and a continuous phase (sea phase, convex portion) of sample G3 in FIG. 2.

FIG. 5 is a plan view showing a shape of a test specimen used to measure an elongation rate at break of a release film.

### DESCRIPTION OF EMBODIMENTS

Hereinafter, embodiments in the present disclosure will be described in detail. It is to be noted, however, that the present disclosure is not limited to the following embodiments. In the embodiments described below, components thereof (including element steps and the like) are not essential, unless otherwise specified. The same applies to numerical values and ranges thereof, and the present disclosure is not limited thereto.

In the present disclosure, the term “process” includes not only a process independent of other processes, but also a process that cannot be clearly distinguished from other processes, as long as the purpose of the process is achieved.

In the present disclosure, a numerical ranges indicated using “to” include the numerical values before and after “to” as the minimum and maximum values, respectively.

In the present disclosure, in the numerical ranges described step by step in the present disclosure, the upper limit or lower limit of one numerical range may be replaced with the upper or lower limit of another numerical range described step by step. Moreover, in the numerical ranges described in the present disclosure, the upper or lower limits of the numerical ranges may be replaced with the values shown in the examples.

In the present disclosure, each component may contain multiple types of applicable substances. In a case in which a composition contains multiple substances corresponding to each component, a content or amount of each component means a total content or amount of the multiple substances present in the composition, unless otherwise specified.

In the present disclosure, the term “layer” comprehends herein not only a case in which the layer is formed over the whole observed region where the layer is present, but also a case in which the layer is formed only on part of the region.

In the disclosure, a thickness of a release film or each layer constituting the release film can be measured by a known method. For example, it may be measured using a dial gauge or the like, or it may be measured from a cross-sectional image of the release film. Alternatively, the material constituting the layer may be removed using a solvent or the like, and a thickness may be calculated from a mass before and after removal, a density of the material, an area of the layer, or the like. In a case in which the thickness of the layer is not constant, an arithmetic average of values measured at any five points is taken as the thickness of the layer.

In the present disclosure, “(meth)acrylic” means either or both of acrylic and methacrylic, “(meth)acrylate” means either or both of acrylate and methacrylate, and “(meth)acryloyl” means either or both of acryloyl and methacryloyl.

In a case in which embodiments are described with reference to drawings in the present disclosure, a configuration of the embodiment is not limited to the configuration shown in the drawings. Furthermore, sizes of components in each figure are conceptual, and relative relationships in size between components are not limited to these.

### <Release Film>

A release film in the present disclosure includes a release layer and a substrate layer, the release layer includes two or more polymers, and satisfies at least one of the following (1) to (4).

(1) The release layer has a plurality of regions with different component ratios, and in a case in which Raman spectroscopy is performed on the different regions, at least a part of the different regions exhibit different peak intensities.

(2) A surface of the release layer has a convex portion and a concave portion, and in a case in which Raman spectroscopy is performed on the convex portion and the concave portion, at least a part of the convex portion and at least a part of the concave portion exhibit different peak intensities.

(3) A difference in SP value between at least two of the polymers is 0.3 or more.

(4) At least one of the polymers is a nitrile group-containing (meth)acrylic polymer.

In the present disclosure, “polymer” refers to a high molecular weight component that does not contain an organic filler. The organic filler is insoluble or poorly soluble in organic solvents (for example, toluene, methyl ethyl ketone, and ethyl acetate) that can be used to prepare the release layer forming composition. Insoluble or poorly soluble in organic solvents means that in a gel fraction test according to JIS K6769 (2013), the gel fraction after dispersing resin particles in an organic solvent such as toluene and holding at 50° C. for 24 hours is 97% by mass or more.

In the present disclosure, “different types of polymers” means that types of constituent monomers are different, or a content of structural units derived from at least one monomer differs by 1% by mass or more although types of constituent monomers are the same.

In the disclosure, “exhibiting different peak intensities in a case in which Raman spectroscopy is performed” means that an intensity of a peak that appears at a certain position in a Raman spectrum obtained by Raman spectroscopy is different, and a difference in the presence or absence of a peak at a certain position is also included in the difference in exhibiting peak intensity.

In the present disclosure, “convex portion” and “concave portion” refer to a region that is higher or lower than other regions in the thickness direction. For example, in a case in which the reference surface is assumed to be a concave portion, a region that is higher than the reference surface may be the convex portion, or in a case in which the reference surface is assumed to be a convex portion, a region that is lower than the reference surface may be the concave portion.

The release film in the present disclosure having the above configuration has excellent elongation and can reduce flow marks on a surface of a molded semiconductor package. The reason for this is not clear, but is presumed to be as follows. Note that the release film in the present disclosure is in no way limited by the following presumption.

As described in (1), by having a plurality of regions with different component ratios and exhibiting different peak intensities in at least a portion of the different regions in a case in which Raman spectroscopy is performed on the different regions, in one region, polymers aggregate to increase in density and rise partially, thereby forming a convex portion and a concave portion on the surface of the release layer. The fact that there are regions that exhibit different peak intensities in a case in which Raman spectroscopy is performed may mean that component ratios of the regions that exhibit different peak intensities are different.

As described in (2), the release layer may have a convex portion and a concave portion, and in a case in which Raman spectroscopy is performed on the convex portion and the concave portion, at least a part of the convex portion and at least a part of the concave portion exhibit different peak intensities. Exhibiting different peak intensities in a case in which Raman spectroscopy is performed on the convex portion and the concave portion simply means that at least a part of the convex portion and at least a part of the concave portion exhibit different peak intensities in a case in which Raman spectroscopy is performed. In a case in which there are a plurality of convex portions, the peak intensities of the respective convex portions may be the same or different. In the case where there are a plurality of concave portions, the peak intensities of the concave portions may be the same or different.

Therefore, it is believed that the release film described in (1) or (2) may generate a convex portion and a concave portion on the surface of the release film without adding a filler to the release layer.

As a specific method for forming a plurality of regions with different component ratios, as described in (3), two or more polymers with a difference in SP value of 0.3 or more are used. Polymers with a difference in SP value of 0.3 or more have low compatibility and therefore separate from each other while the same type of polymers aggregate with each other, and the release films of (1) and (2) may be obtained. In particular, as described in (4), in a case in which at least one of the polymers is a nitrile group-containing (meth)acrylic polymer, the nitrile group-containing (meth)acrylic polymers tend to aggregate with each other to form a convex portion.

In conventional release films, a filler is added to the release layer to generate unevenness on the surface of the release layer, thereby reducing flow marks of a sealing material on a surface of the semiconductor package. However, in such conventional release films, the release layer is prone to tearing starting from the filler, and since conventional release films contain a filler, they are difficult to stretch.

In contrast, in the release film in the present disclosure, which satisfies at least one of (1) to (4), a convex portion and a concave portion may be created on the surface without adding a filler, making it possible to eliminate the need to add a filler or to reduce the amount of filler, resulting in excellent elongation. In addition, in the release film in the present disclosure, since a convex portion and a concave portion appears on the surface, flow marks of a sealing material on a surface of the semiconductor package are reduced.

Furthermore, since a convex portion and a concave portion appears on the surface of the release film in the present disclosure, it is also excellent in releasability. In addition, since filler is not required to be added to the release film in the present disclosure, it is possible to suppress an occurrence of defects such as the drop-off of the filler. Therefore, it is possible to form a convex portion where no clear interface is confirmed in the release film in the present disclosure. A convex portion where no clear interface is confirmed means that, when observed with a laser microscope, particle interface such as those observed in the case of adding a filler are not observed.

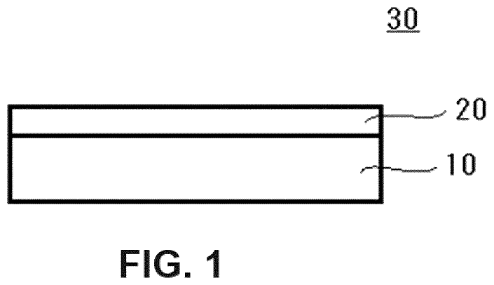

As an example of the release film in the present disclosure, a cross-sectional configuration of the release film is shown in FIG. 1. As shown in FIG. 1, the release film 30 includes a substrate layer 10 and a release layer 20. The release film 30 may have other layers. Examples of the other layers include a second release layer, an anchoring improvement layer, an antistatic layer, and a colored layer.

### [Release Layer]

The release layer contains at least two types of polymers.

The difference in SP value between the at least two types of polymers contained in the release layer is preferably 0.3 or more, more preferably 0.5 or more, and even more preferably 0.8 or more. An upper limit of the difference in SP value is not particularly limited, and is preferably 5.0 or less, more preferably 4.0 or less, and even more preferably 3.0 or less.

In the present disclosure, in a case in which the release layer contains two polymers, the difference in SP value refers to a difference in SP value between the respective polymers. In a case in which the release layer contains three or more polymers, the difference in SP value refers to a difference in SP value between the polymer with the highest SP value and the polymer with the lowest SP value among the polymers contained in the release layer.

The SP value is a solubility parameter derived from the partial structural units of a chemical structural formula, and is a value obtained by the Fedors method.

A type of polymer is not particularly limited, and is preferably selected in consideration of the adhesion, releasability, heat resistance or the like of the release layer. Specifically, Examples of the polymer include a (meth)acrylic polymer having a structural unit derived from a (meth)acryloyl monomer, silicone, and urethane polymer. At least one of polymers is preferably a (meth)acrylic polymer, and more preferably two or more of (meth)acrylic polymers are used.

A content of the (meth)acrylic polymer in a total polymer is preferably 20% by mass or more, more preferably 40% by mass or more, even more preferably 60% by mass or more, and may be 80% by mass or more, 85% by mass or more, 90% by mass or more, or 95% by mass or more. An upper limit is not particularly limited, and may be 100% by mass, 95% by mass or less, 90% by mass or less, or 85% by mass or less.

The (meth)acrylic polymer may be a homopolymer or a copolymer, and a homopolymer and a copolymer may be used in combination. At least one of the (meth)acrylic polymers is preferably a copolymer. The copolymer may contain a structural unit derived from monomer A having no functional group, or may contain a structural unit derived from monomer B having a functional group.

Monomer A is preferably a monomer having a relatively low glass transition temperature (Tg) (for example, −20° C. or lower). A monomer having a relatively low Tg refers to a monomer having a relatively low glass transition temperature in a case in which a homopolymer is synthesized from the monomer. Examples of monomer A include butyl (meth)acrylate, ethyl (meth)acrylate, and 2-ethylhexyl (meth)acrylate. The copolymer may contain one type of structural unit derived from monomer A singly, or two or more types in combination.

In a case in which the copolymer contains a structural unit derived from monomer A, a total content of the structural units derived from monomer A in the copolymer is preferably more than 50% by mass, more preferably 55% by mass or more, and even more preferably 60% by mass or more. The total content is preferably 99% by mass or less, more preferably 98% by mass or less, and even more preferably 97% by mass or less.

It is preferable that at least one polymer is a copolymer containing a structural unit derived from monomer B having a functional group. Examples of the functional group include a carboxylic acid group, a hydroxyl group, an amide group, and a nitrile group. The functional group may be a crosslinkable functional group or a non-crosslinkable functional group. Examples of the crosslinkable functional group include a carboxylic acid group, a hydroxyl group, and an amide group, and examples of the non-crosslinkable functional group include a nitrile group. The copolymer may contain one type of structural unit derived from monomer B singly, or a combination of two or more types. It is more preferable that at least one polymer is a nitrile group-containing (meth)acrylic polymer.

The crosslinked polymer having a crosslinkable functional group may be at least partially crosslinked in the release film. In the present disclosure, an embodiment in which the release film includes two or more polymers include those in which the two or more polymers are already crosslinked in the release film.

In a case in which the polymer is crosslinked, it is possible to analyze or estimate the polymer before crosslinking by decomposing the bond at the crosslinking point. For example, in a case in which the polymer has a hydroxyl group and an isocyanate compound is used as a crosslinking agent, it is presumed that the crosslinking occurs by forming a urethane bond, and the urethane bond may be selectively decomposed by pyridine.

The crosslinked polymer is preferably a crosslinkable (meth)acrylic polymer, and preferably a crosslinkable (meth)acrylic copolymer.

Examples of the monomer B1 having a crosslinkable functional group include (meth)acrylic acid, hydroxymethyl (meth)acrylate, hydroxyethyl (meth)acrylate, and (meth)acrylamide. Examples of the monomer B2 having a non-crosslinkable functional group include (meth)acrylonitrile.

In the at least one polymer, a total content of structural units derived from monomer B1 is preferably 0.1% by mass or more, more preferably 0.5% by mass or more, and even more preferably 1.0% by mass or more. The total content is preferably 30% by mass or less, more preferably 25% by mass or less, and even more preferably 20% by mass or less.

In the at least one polymer, a total content of structural units derived from monomer B2 is preferably 1% by mass or more, more preferably 3% by mass or more, and even more preferably 5% by mass or more. The content is preferably 40% by mass or less, more preferably 35% by mass or less, and even more preferably 30% by mass or less.

At least one of the polymers is preferably a copolymer containing a structural unit derived from a monomer having a nitrile group, and more preferably a copolymer containing a structural unit derived from a (meth)acrylonitrile monomer. The polymer used in combination may be a homopolymer that does not contain a structural unit derived from a monomer having a nitrile group, or may be a copolymer that does not contain a structural unit derived from a monomer having a nitrile group.

A content of the structural unit derived from a monomer having a nitrile group in the copolymer containing the structural unit derived from a monomer having a nitrile group is preferably 1% by mass or more, more preferably 3% by mass or more, and even more preferably 5% by mass or more. The content is preferably 40% by mass or less, more preferably 35% by mass or less, and even more preferably 30% by mass or less.

A total content of the structural units derived from monomer A in the copolymer containing the structural unit derived from a monomer having a nitrile group is preferably 50% by mass or more, more preferably 55% by mass or more, and even more preferably 60% by mass or more. The total content is preferably 94% by mass or less, more preferably 92% by mass or less, and even more preferably 90% by mass or less.

A total content of the structural units derived from monomer B1 in a copolymer containing a structural unit derived from a monomer having a nitrile group is preferably 0.1% by mass or more, more preferably 0.5% by mass or more, and even more preferably 1.0% by mass or more. The total content is preferably 30% by mass or less, more preferably 25% by mass or less, and even more preferably 20% by mass or less.

A total content of the structural units derived from monomer A in a copolymer not containing the structural unit derived from a monomer having a nitrile group is preferably 70% by mass or more, more preferably 75% by mass or more, and even more preferably 80% by mass or more. The total content is preferably 99% by mass or less, more preferably 98% by mass or less, and even more preferably 97% by mass or less.

A total content of the structural units derived from monomer B1 in a copolymer not containing the structural unit derived from a monomer having a nitrile group is preferably 0.1% by mass or more, more preferably 0.5% by mass or more, and even more preferably 1.0% by mass or more. The total content is preferably 30% by mass or less, more preferably 25% by mass or less, and even more preferably 20% by mass or less.

In at least two types of polymers, the difference in the proportion of the structural unit derived from a (meth)acrylonitrile monomer is preferably 1% by mass or more, more preferably 3% by mass or more, and even more preferably 5% by mass or more. There is no particular upper limit for the difference in the proportion of the structural unit derived from a (meth)acrylonitrile monomer, and it is preferably 40% by mass or less, more preferably 35% by mass or less, and even more preferably 30% by mass or less.

Preferred combinations of two types of (meth)acrylic polymers include, for example, the following (I) and (II), and the following (I) is preferred.
(I) A combination of a nitrile group-containing (meth)acrylic polymer and a (meth)acrylic polymer that does not contain a nitrile group
(II) Both are nitrile group-containing (meth)acrylic polymers, and have different contents of the structural unit derived from (meth)acrylonitrile monomer.

A number average molecular weight (Mn) of the polymer may be, for example, 1.0×10³ or more, 1.0×10⁴ or more, 1.0×10⁵ or more, or 1.2×10⁵ or more. It may also be, for example, 1.0×10⁶ or less, or 5.0×10⁵ or less.

A weight average molecular weight (Mw) of the polymer may be, for example, 1.0×10³ or more, 1.0×10⁴ or more, 1.0×10⁵ or more, 3.0×10⁵ or more, or 5.0×10⁵ or more. It may also be, for example, 5.0×10⁶ or less, or 1.0×10⁶ or less.

The Mn and Mw of the polymer are measured by a normal method using GPC (gel permeation chromatography).

A content of the polymer with the highest content in the release layer is preferably 95 mass % or less, more preferably 90 mass % or less, and even more preferably 85 mass % or less, with respect to a total content of polymers. In a case in which the content of the polymer with the highest content is 95 mass % or less, a convex portion and a concave portion tend to be easily formed on the surface of the release film.

In a case in which the polymer is a crosslinkable polymer, it is preferable to use a crosslinking agent. Examples of the crosslinking agent include known crosslinking agents such as an isocyanate compound, a melamine compound, and an epoxy compound. From the viewpoint of forming a gently spreading mesh-like structure, it is more preferable that the crosslinking agent is a multifunctional crosslinking agent such as a trifunctional or tetrafunctional crosslinking agent.

The isocyanate crosslinking agent is not particularly limited, and may be selected from known compounds having an isocyanate group (isocyanate compounds). From the viewpoint of reactivity, a bifunctional isocyanate compound (compound having two isocyanate groups) and a multifunctional isocyanate compound (compound having three or more isocyanate groups) are preferred, and a multifunctional isocyanate compound is more preferred.

Examples of the bifunctional isocyanate compound include an aliphatic diisocyanate compound, an alicyclic diisocyanate compound, an aromatic diisocyanate compound, a carbodiimide-modified product of at least one of these diisocyanate compounds, and a polymeric compound having at least one of these diisocyanate compounds in the molecule.

Examples of the aliphatic diisocyanate compound include 1,5-pentamethylene diisocyanate, 1,6-hexamethylene diisocyanate (HDI), trimethylhexamethylene diisocyanate (TMHDI), lysine diisocyanate, and norbornane diisocyanate methyl (NBDI).

Examples of the alicyclic diisocyanate compound include transcyclohexane-1,4-diisocyanate, isophorone diisocyanate (IPDI), H6-XDI (hydrogenated XDI), and H12-MDI (hydrogenated MDI).

Examples of the aromatic diisocyanate compound include dimer acid diisocyanate, 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, xylylene diisocyanate (XDI), tetramethylxylene diisocyanate (TMXDI), tolidine diisocyanate (TODI), and 1,5-naphthalene diisocyanate (NDI).

Examples of the multifunctional isocyanate compound include a trimer of bifunctional isocyanate compounds, and a polymeric compound having a trimer of bifunctional isocyanate compounds in the molecule.

Examples of the trimer of bifunctional isocyanate compound include isocyanurates of the bifunctional isocyanate compound, an adduct of the bifunctional isocyanate compound, and a biuret compound of the bifunctional isocyanate compound.

A content of the crosslinking agent in the release layer may be, for example, from 0.1 parts by mass to 50 parts by mass or from 1 part by mass to 40 parts by mass, with respect to 100 parts by mass of a solid content of the polymer in the release layer.

The release layer may contain an anchoring enhancer, a crosslinking promoter, a colorant, an antistatic agent or the like, as necessary. For example, in a case in which the release layer contains an antistatic agent, discharge is less likely to occur during peeling, and electrostatic damage to electronic components is suppressed.

The release layer preferably has a plurality of different regions with different component ratios, and in a case in which Raman spectroscopy is performed on the different regions, at least a part of the different regions preferably exhibit different peak intensities. In addition, it is preferable that the surface of the release layer has a convex portion and a concave portion, and in a case in which Raman spectroscopy is performed on the convex portion and the concave portion, at least a part of the convex portion and at least a part of the concave portion exhibit different peak intensities.

As an example, a component ratio of the polymers may be different in at least a part of the plurality of the different regions, or in at least a part of the convex portion and at least a part of the concave portion. As a further specific example, it is preferable that a content of the nitrile group-containing (meth)acrylic polymer is different in at least a part of the plurality of the different regions, or in at least a part of the convex portion and at least a part of the concave portion. Moreover, it is preferable that the peaks exhibiting different peak intensities are peaks derived from nitrile groups.

In the release layer, it is preferable that at least one region contains a nitrile group-containing (meth)acrylic polymer, and the other region may or may not contain a nitrile group-containing (meth)acrylic polymer. From the viewpoint of easily creating a convex portion and a concave portion on the surface of the release layer, it is preferable that the other region does not contain a nitrile group-containing (meth)acrylic polymer. An absence of a nitrile group-containing (meth)acrylic polymer in a region may be confirmed by not detecting a spectral peak corresponding to a nitrile group in a case in which the region is subjected to a component analysis by microscopic Raman spectroscopy described later.

In a case in which the surface of the release layer is observed in plan view, each region may exhibit a phase separation state within the layer, forming a continuous phase and a discontinuous phase. An area ratio of the continuous phase and the discontinuous phase may be adjusted by a blending ratio of the polymers contained in the release layer. A polymer with a low content in the release layer is included in the discontinuous phase, and a polymer with a high content is included in the continuous phase.

Furthermore, it is preferable that the surface of the release layer has a convex portion and a concave portion, and a peak intensity derived from the nitrile group in at least a part of the convex portion is greater than a peak intensity derived from the nitrile group in at least a part of the concave portion. Furthermore, it is preferable that the surface of the release layer has a convex portion and a concave portion, and a content by mass of the nitrile group-containing (meth)acrylic polymer in at least a part of the convex portion is greater than a content by mass of the nitrile group-containing (meth)acrylic polymer in at least a part of the concave portion.

A Raman spectrometer is used for the Raman spectroscopy measurement of each region, and a convex and concave portions. For example, “DXR2xi” manufactured by Thermo Fischer Scientific is used as the Raman spectrometer, and measurements are performed under the following conditions.
Wavelength: 532 nm
Power: 10 mW
Exposure time: 0.05 seconds
Number of scans: 1000
Aperture: 25 μm pinhole
Objective lens: 100×

The component ratios in each region and a convex and concave portions are measured by obtaining a spectrum by Raman spectroscopy for each point irradiated with the laser. For example, a peak of the Raman spectrum for a specific component (e.g., nitrile group) that constitutes the release layer is identified in advance, and a relative content of the specific component at one point and another point is confirmed based on the signal intensity.

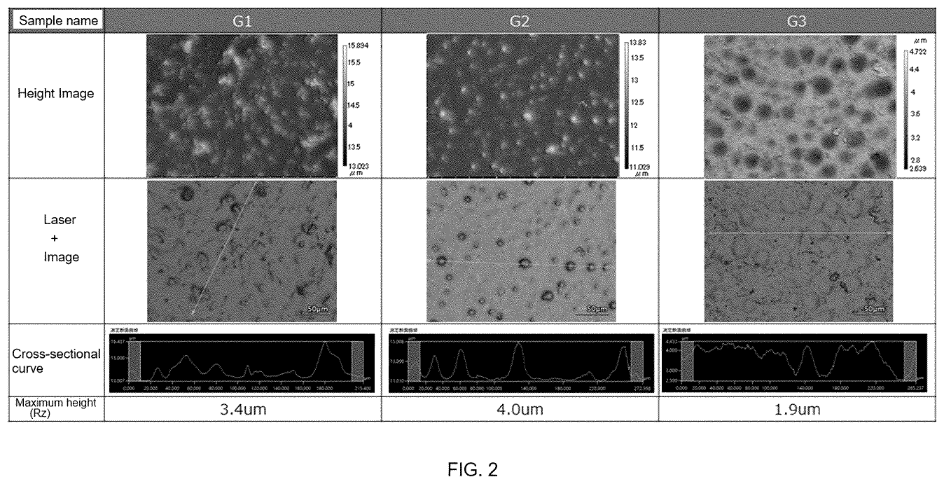

FIG. 2 shows a laser microscope photograph and an analysis graph of a surface of a release layer. In FIG. 2, the laser microscope used is Keyence's “VK-X3000,” and observations are performed with a 50× objective lens. Although the above-mentioned laser microscope was used in FIG. 2, other laser microscopes may be used to view the surface of the release layer.

In FIG. 2, sample G1 is a conventional release layer containing a filler, and samples G2 and G3 are release layers in the present disclosure that use a nitrile group-containing (meth)acrylic polymer (polymer A) and a nitrile group-free (meth)acrylic polymer (polymer B) in combination. In sample G2, a content of polymer A in a total polymer is 15% by mass, and a content of polymer B is 85% by mass. In sample G3, a content of polymer A in a total polymer is 85% by mass, and a content of polymer B is 15% by mass.

First and second rows of FIG. 2 are planar photographs of the surface of the release layer, and third row is a cross-sectional curve obtained by analyzing the convex and concave portions of the surface along the straight line indicated by the arrow in the second row of the photograph.

As shown in FIG. 2, in samples G2 and G3, the plurality of regions are formed in the release layer.

In sample G2, a content of nitrile group-containing (meth)acrylic polymer in a total polymer is less than half, and in this case, an area of a convex portions occupying an entire surface is less than half. On the other hand, in sample G3, a content of nitrile group-containing (meth)acrylic polymer in a total polymer is more than half, and in this case, an area of a convex portions occupying an entire surface is more than half. This shows that a content of nitrile group-containing (meth)acrylic polymer is higher in the convex portion than in the concave portion.

Furthermore, as shown in FIG. 2, in the conventional sample G1, the filler aggregates, and therefore a uniformity of the shape, size and the like of the convex portions is low.

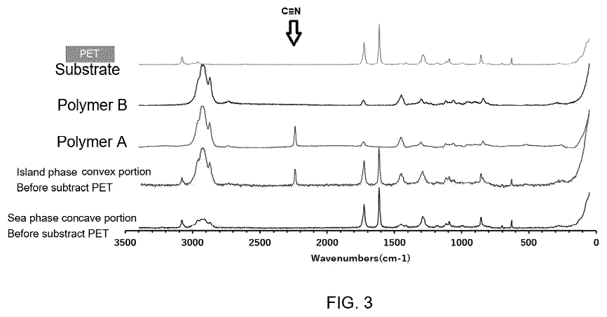

FIG. 3 shows a spectrum results of component analysis by microscopic Raman spectroscopy of a discontinuous phase (island phase, convex portion) and a continuous phase (sea phase, concave portion) of sample G2 in FIG. 2. Here, the discontinuous phase refers to a region that occupies a small area on the observation surface, and the continuous phase refers to a region that occupies a large area on the observation surface.

In FIG. 3, a peak due to a nitrile group is detected in the discontinuous phase (convex portion), whereas no peak due to nitrile groups is detected in the continuous phase (concave portion). From this result, it can be seen that the component ratios of polymers is different between the discontinuous phase (convex portion) and the continuous phase (concave portion). It can also be seen that a content of the nitrile group-containing (meth)acrylic polymer is greater in the convex portion than in the concave portion.

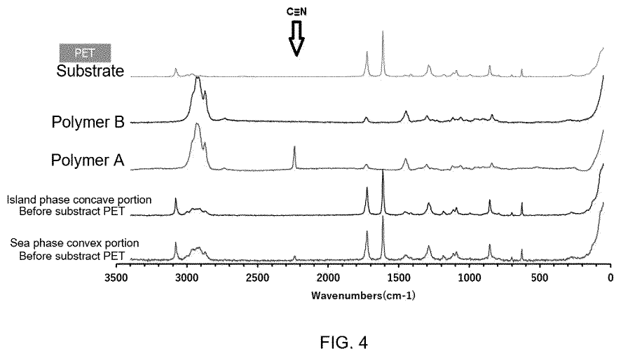

FIG. 4 shows a spectrum results of component analysis by microscopic Raman spectroscopy of a convex portion (sea phase, continuous phase) and a concave portion (island phase, discontinuous phase) of sample G3 in FIG. 2. A peak derived from nitrile groups is detected in the convex portion, whereas no peak derived from nitrile groups is detected in the concave portion. From this result, it can be seen that the component ratios of the polymers are different between the convex portion and the concave portion. It can also be seen that a content of the nitrile group-containing (meth)acrylic polymer is greater in the convex portion than in the concave portion.

In FIG. 4, the nitrile group-containing (meth)acrylic polymer is contained as the main component in a total polymer at more than 50% by mass and forms a continuous phase, and this continuous phase forms the convex portion. In FIG. 3, the continuous phase forms the concave portion, whereas in FIG. 4, this is reversed. However, in both the cases of FIGS. 3 and 4, a content of the nitrile group-containing (meth)acrylic polymer is greater in the convex portion than in the concave portion.

A thickness of the release layer is not particularly limited, and is preferably 1 μm or more, more preferably 3 μm or more, and even more preferably 5 μm or more. In a case in which the thickness of the release layer is 1 μm or more, sufficient adhesion to electronic components is obtained, and an intrusion of a sealing material is effectively suppressed.

The thickness of the release layer may be 50 μm or less, or may be 25 μm or less. In a case in which the thickness of the release layer is 50 μm or less, thermal shrinkage stress of the release layer is unlikely to occur during thermal curing, and flatness of the release film is easily maintained. Furthermore, in a case in which the release film has a conductive layer, a distance from the conductive layer to the surface of the release layer is not too far, so that the surface resistivity is kept low, and electrostatic damage to electronic components is effectively suppressed.

From the viewpoint of totally considering the ease of forming the release layer (coatability or the like), ensuring adhesion and the like, the thickness of the release layer is preferably from 1 μm to 50 μm, and more preferably from 3 μm to 25 μm.

From the viewpoint of maximizing the effect of the embodiment in the present disclosure, it is preferable that the release layer does not contain a filler, but it may contain a filler. In a case in which a filler is used, it may be at least one of an organic filler or an inorganic filler. A content of the filler in the release layer may be, for example, from 1% by volume or less, 0.5% by volume or less, or 0.1% by volume or less. The content (% by volume) of the filler in the release layer may be calculated with respect to a density measured by the Archimedes method and a specific gravity of the resin component and the filler.

### (Elongation Rate at Break of Release Layer)

Elongation rate at break of the release layer is preferably 100% or more, more preferably 120% or more, and even more preferably 150% or more. For example, in a case in which the release layer contains at least one nitrile group-containing (meth)acrylic polymer, the elongation rate at break of the release layer can be adjusted by an amount of the nitrile group-containing (meth)acrylic polymer. The upper limit of the elongation rate at break of the release layer is not particularly limited, and may be, for example, 800% or less, 500% or less, or 300% or less.

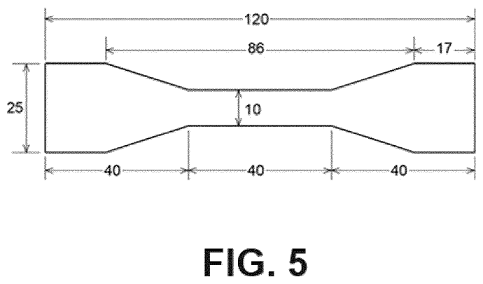

The elongation rate (%) at break of the release layer in the release film is measured as follows. First, a test piece having a shape as shown in FIG. 5 is prepared using the release film. Both ends of this test piece are gripped by a testing machine and a tensile test is performed. The measurement is performed under conditions of 170° C. and the tensile speed is 200 mm/min. The elongation rate at break of the release layer is calculated from the following formula using the gauge length A (the length at a part of the test piece with a width of 10 mm shown in FIG. 5: 40 mm) of the sample before the test and the gauge length B when the release layer breaks.

$$Elongated rate at break of release layer ( \% ) = \frac{B - A}{A} \times 100$$

To measure the elongation rate at break of the release layer in the release film, for example, a Tensilon tensile tester RTA-100 manufactured by Orientec Co., Ltd., a Tensilon universal tester RTG-1210 manufactured by A&D Co., Ltd., or a similar tester having a gripper is used.

### (Surface Roughness of Release Layer)

An arithmetic mean roughness (Ra) of the outer surface of the release layer (the surface opposite to the surface facing the substrate layer) is preferably 0.2 μm or more, more preferably 0.25 μm or more, and even more preferably 0.3 μm or more. The upper limit of the arithmetic mean roughness (Ra) is not particularly limited, and it may be, for example, 2.5 μm or less, 2.0 μm or less, 1.5 μm or less, or less than 1.0 μm.

The arithmetic mean roughness (Ra) of the outer surface of the release layer may be obtained by analyzing the results measured using a surface roughness measuring device (for example, Kosaka Laboratory Ltd., Model No. SE-3500) under conditions of a stylus tip diameter of 2 μm, a feed rate of 0.5 mm/s, and a scanning distance of 8 mm, according to JIS B0601 (1994) or ISO 4287 (1997).

The arithmetic mean roughness (Ra) of the outer surface of the release layer may be adjusted by a blending ratio of the polymer contained in the release layer, a thickness of the release layer, an amount of crosslinking agent if a crosslinking agent is used, or an amount of catalyst if a catalyst is used.

### [Substrate Layer]

The substrate layer is not particularly limited and may be appropriately selected from substrate layers used in the relevant technical field. From the viewpoint of improving mold shape conformability, it is preferable to use a resin-containing substrate layer having excellent stretchability.

Considering the heating temperature (approximately 100° C. to 200° C.) for molding the sealing material, it is preferable that the substrate layer has heat resistance equal to or higher than the heating temperature. In addition, from the viewpoint of suppressing an occurrence of wrinkles, tears or the like when the release film is attached to the mold and when the sealing material flows, it is preferable to select a material of the substrate layer in consideration of the elastic modulus and elongation when heated.

From the viewpoint of heat resistance and elastic modulus when heated, the material of the substrate layer is preferably a polyester resin. Examples of the polyester resin include polyethylene terephthalate resin, polyethylene naphthalate resin, and polybutylene terephthalate resin, as well as copolymers and modified resins thereof.

The substrate layer is preferably in the form of a sheet, preferably a polyester resin molded into a sheet, more preferably a polyester film, and from the viewpoint of conformity to the mold, even more preferably a biaxially stretched polyester film.

A thickness of the substrate layer is not particularly limited, and is preferably from 5 μm to 200 μm, and more preferably from 10 μm to 100 μm. In a case in which the thickness is 5 μm or more, the sheet has excellent handleability and tends to be less prone to wrinkles. In a case in which the thickness is 200 μm or less, the sheet has excellent conformability to a mold during molding, and thus tends to suppress an occurrence of wrinkles and the like in a molded semiconductor package.

### [Other Configurations]

Depending on the material of the substrate layer, it is preferable to design it so that the release sheet can be easily peeled off from the mold. For example, a surface of the substrate layer opposite to the release layer, that is, a surface of the substrate layer facing the mold, may be subjected to a surface treatment such as matte finish, or may be provided with another release layer (second release layer). A material of the second release layer is not particularly limited as long as it satisfies the requirements for peelability from the mold, beat resistance, or the like, and the same material as the release layer described above (hereinafter also referred to as the “specific release layer”). A thickness of the second release layer is not particularly limited, and preferably from 0.1 μm to 100 μm.

Furthermore, if necessary, an anchoring improvement layer, an antistatic layer, a colored layer or the like may be provided between the specific release layer and the substrate layer, between the substrate layer and the second release layer, or the like.

### <Method of Producing Release Film>

The release film in the present disclosure may be produced by a known method. For example, the release film in the present disclosure may be produced by applying a release layer forming composition to the substrate layer and drying it. The release layer forming composition contains at least two of the above-mentioned polymers, and may further contain other resin components and other components added as desired.

### [Preparation of Release Layer Forming Composition]

The method of preparing the release layer forming composition is not particularly limited, and a known composition preparation method may be used. A solvent used for preparing the release layer forming composition is not particularly limited, and is preferably an organic solvent capable of dissolving the polymer. Examples of the organic solvent include toluene, methyl ethyl ketone, and ethyl acetate.

### [Applying and Drying]

A method for applying the release layer forming composition to the substrate layer is not particularly limited, and known coating methods such as roll coating, bar coating, and kiss coating may be used. It is preferable to appropriately adjust an amount of the release layer forming composition applied so that a thickness of the composition layer formed after drying is close to a thickness of the desired release layer (for example, from 1 μm to 50 μm).

A method for drying the applied release layer forming composition is not particularly limited, and a known drying method may be used. For example, a method of drying at from 50° C. to 150° C. for from 0.1 to 60 minutes may be used.

### <Uses of Release Film>

The release film in the present disclosure is used when sealing a semiconductor chip with a sealing material. The release film in the present disclosure is preferably used for transfer molding or compression molding.

By using the release film in the present disclosure, it is possible to easily remove a semiconductor package (molded product) from a mold while suppressing damage to the semiconductor package. In addition, by using the release film in the present disclosure, flow marks of the sealing material on the surface of the semiconductor package (molded product) are suppressed, resulting in excellent uniformity in appearance. Furthermore, even when used in a situation where the release film is required to elongate, breakage of the release layer is suppressed, so even in such a usage pattern, it is possible to easily remove a semiconductor package (molded product) from a mold while suppressing damage to the semiconductor package.

### <Method of Producing Semiconductor Package>

A method of producing a semiconductor package disclosed includes carrying out a transfer molding process or a compression molding process using the release film in the present disclosure.

In the method of producing a semiconductor package, first, the release film in the present disclosure is placed on a mold of a molding device, and the release film is fitted to a shape of the mold. Examples of the method of fitting the release film to a shape of the mold include vacuum adsorption.

Then, a semiconductor chip is sealed with a sealing material in the mold to which the release film has been fitted. With the semiconductor chip and the release film placed in the mold, the semiconductor chip may be sealed with the sealing material to produce a semiconductor package. After producing the semiconductor package, the mold is opened and the molded semiconductor package is removed.

In the method of producing a semiconductor package in the present disclosure, the release film in the present disclosure is used, whereby flow marks of the sealing material on the surface of the semiconductor package are suppressed, and a semiconductor package with excellent uniformity in appearance may be obtained. Furthermore, even when used in a situation where the release film is required to elongate, breakage of the release layer is suppressed, whereby the semiconductor package may be easily removed from the mold while suppressing damage to the semiconductor package.

Examples of the semiconductor chip used in the above method include a semiconductor element, a capacitor, and a terminal. A type of sealing material used in the above method is not particularly limited, and examples thereof include a resin composition containing an epoxy resin, an acrylic resins or the like.

### EXAMPLES

The present invention will be specifically described below with reference to examples. However, the present invention is not limited to these examples.

### Synthesis of Synthetic Resins 1 to 4

Monomers shown in Table 1 below were used in an amounts (parts by mass) shown in Table 1 and copolymerized by solution polymerization to obtain synthetic resins 1 to 4.

A number average molecular weight Mn and a weight average molecular weight Mw of the obtained synthetic resins 1 to 4 were measured by gel permeation chromatography (PC) using standard polystyrene equivalents.

The SP values of the obtained synthetic resins 1 to 4 are shown in Table 1.

TABLE 1

| | Synthetic | Synthetic | Synthetic | Synthetic |
|---|---|---|---|---|
| Monomer | resin 1 | resin 2 | resin 3 | resin 4 |
| BA | 92 | 0 | 88 | 71 |
| 4-HBA | 8 | 0 | 0 | 0 |
| MMA | 0 | 59 | 0 | 0 |
| 2-HEA | 0 | 28 | 0 | 0 |
| 2-HEMA | 0 | 13 | 1 | 5 |
| AN | 0 | 0 | 11 | 24 |
| Mn | 144,000 | 56,000 | 140,000 | 140,000 |
| Mw | 854,000 | 120,000 | 910,000 | 610,000 |
| SP value | 10.0 | 10.2 | 10.3 | 11.0 |

The monomers in Table 1 represent the following.
BA: Butyl acrylate
4-HBA: 4-hydroxybutyl acrylate
MMA: methyl methacrylate
2-HEA: 2-hydroxyethyl acrylate
2-HEMA: 2-hydroxyethyl methacrylate
AN: Nitrile acrylic acid

### Example 1

To a total of 100 parts by mass of synthetic resin 1 (85 parts by mass) and synthetic resin 3 (15 parts by mass), 20 parts by mass of Coronate L (product name, Nippon Polyurethane Industry Co., Ltd.) as a crosslinking agent was added to toluene to prepare a toluene solution with a solid content of 15% by mass, and a composition for forming a release layer was prepared. As the substrate layer, a biaxially stretched polyethylene terephthalate film (S-38, Unitika Co., Ltd.) with a thickness of 38 μm was used and corona treatment was performed. Thereafter, a release layer was formed on one side of a substrate layer using a roll coater by applying a release layer composition and drying so that an average thickness after drying was 20 μm, and a release film was obtained.

### Example 2

A release film was produced in the same manner as in Example 1, except that the average thickness after drying of the release layer was 10 μm.

### Example 3

A release film was produced in the same manner as in Example 1, except that the average thickness after drying of the release layer was 5 μm.

### Example 4

A release film was produced in the same manner as in Example 3, except that synthetic resin 1 (90 parts by mass) and synthetic resin 3 (10 parts by mass) were used.

### Example 5

A release film was produced in the same manner as in Example 3, except that 10 parts by mass of the crosslinking agent was used with respect to a total amount of 100 parts by mass of synthetic resin 1 (80 parts by mass) and synthetic resin 3 (20 parts by mass).

### Example 6

A release film was produced in the same manner as in Example 3, except that 30 parts by mass of the crosslinking agent was used with respect to a total amount of 100 parts by mass of synthetic resin 1 (80 parts by mass) and synthetic resin 3 (20 parts by mass).

### Example 7

A release film was produced in the same manner as in Example 3, except that synthetic resin 1 (50 parts by mass) and synthetic resin 3 (50 parts by mass) were used.

### Example 8

A release film was produced in the same manner as in Example 3, except that synthetic resin 1 (20 parts by mass) and synthetic resin 3 (80 parts by mass) were used.

### Example 9

A release film was produced in the same manner as in Example 3, except that synthetic resin 1 (10 parts by mass) and synthetic resin 3 (90 parts by mass) were used.

### Example 10

A release film was produced in the same manner as in Example 3, except that synthetic resin 1 (80 parts by mass) and synthetic resin 4 (20 parts by mass) were used.

### Example 11

A release film was produced in the same manner as in Example 3, except that 30 parts by mass of the crosslinking agent was used with respect to a total amount of 100 parts by mass of synthetic resin 1 (80 parts by mass) and synthetic resin 4 (20 parts by mass).

### Example 12

A release film was produced in the same manner as in Example 3, except that 20 parts by mass of the crosslinking agent was used with respect to a total of 100 parts by mass of synthetic resin 1 (50 parts by mass) and synthetic resin 4 (50 parts by mass).

### Example 13

A release film was produced in the same manner as in Example 3, except that 20 parts by mass of the crosslinking agent was used with respect to a total amount of 100 parts by mass of synthetic resin 1 (20 parts by mass) and synthetic resin 4 (80 parts by mass).

### Example 14

A release film was produced in the same manner as in Example 3, except that 2.2 parts by mass of the crosslinking agent was used with respect to a total amount of 100 parts by mass of synthetic resin 3 (22 parts by mass) and synthetic resin 4 (78 parts by mass).

### Comparative Example 1

A release film was produced in the same manner as in Example 3, except that 10 parts by mass of the crosslinking agent was used with respect to a total amount of 100 parts by mass of synthetic resin 1 (80 parts by mass) and synthetic resin 2 (20 parts by mass).

### Comparative Example 2

A release film was produced in the same manner as in Example 3, except that 40 parts by mass of the crosslinking agent was used with respect to synthetic resin 2 (100 parts by mass), and 15 parts by mass of MX-500 (product name, acrylic particles, average particle size 5 μm, Soken Chemical Industries, Co., Ltd.) was added as a filler.

### Comparative Example 3

A release film was produced in the same manner as in Example 3, except that 10 parts by mass of the crosslinking agent was used with respect to synthetic resin 1 (100 parts by mass).

### Comparative Example 4

A release film was produced in the same manner as in Example 3, except that 20 parts by mass of the crosslinking agent was used with respect to synthetic resin 3 (100 parts by mass).

### <Evaluation Test>

### (Surface Roughness (Ra) of Release Layer)

A surface roughness (Ra) of the release layer of the release film was measured using the method described above. The measurement was performed using the “Surface roughness measuring instrument SE-3500” manufactured by Kosaka Laboratory Ltd. The results are shown in Table 2.

### (Elongation Rate at Break of Release Layer)

Elongation rate at break of the release layer at 170° C. was measured using the method described above. The measurement was performed using the “Tensilon tensile tester RTA-100” manufactured by Orientec Co., Ltd. The results are shown in Table 2.

### (Evaluation of Releasability Against EMC)

As an index of a releasability of the release film after molding a sealing material, a peeling force was measured when a peeling test was carried out at a peeling angle of 180° and a peeling speed of 1000 mm/min. The results were evaluated according to the following criteria. The results are shown in Table 2.

### —Evaluation Criteria—

A: Less than 150 mN/50 mm
B: 150 mN/50 mm or more and less than 250 mN/50 mm
C: 250 mN/50 mm or more

### (Evaluation of Breakage in Release Layer)

A SUS plate (width 50 mm, thickness 0.6 mm) was placed on the substrate layer side of the release film. Teflon (registered trademark) was placed on the release layer side, and a sealing material (Resonac Corporation: product name “CEL-9750ZHF10”) was sprayed between the release layer and the Teflon. The release layer side of the release film was then placed in contact with the sealing material, and a heating and pressurizing treatment was performed at 170° C. and 12.6 MPa for 5 minutes.

The obtained molded package was cut using a “Tabletop Hand Cutter KPS-4002” manufactured by Sun Advance Corporation and cast with epoxy resin. The cast package was polished using abrasive paper with grit sizes of P800, 1500, and 2200 to expose a cross section. The cross section of the polished package was observed with a “Digital Microscope VHX-7000” manufactured by Keyence Corporation to confirm the presence or absence of breakage in the release layer. The results are shown in Table 2.

### (Evaluation of Flow Marks)

The release layer side of the release film was placed against a sealing material (Resonac Corporation: product name “CEL-9750ZHF10”) and subjected to a heat and pressure treatment at 180° C. and 32 MPa for 5 minutes. After the treatment, the package was visually observed to confirm the presence or absence of flow marks caused by the sealing material. The results are shown in Table 2.

TABLE 2

| | | | | | Cross- | | Thick- | | Elongation | | Breakage | |
|---|---|---|---|---|---|---|---|---|---|---|---|---|
| | Synthetic resin | | | | linking | | ness | Ra | rate at | Releas- | in release | Flow |
| | 1 | 2 | 3 | 4 | Agent | Filler | (μm) | (μm) | break (%) | ability | layer | marks |
| Example1 | 85 | | 15 | | 20 | | 20 | 1.5 | 110 | A | absence | absence |
| Example 2 | 85 | | 15 | | 20 | | 10 | 1.2 | 130 | A | absence | absence |
| Example 3 | 85 | | 15 | | 20 | | 5 | 1.0 | 170 | A | absence | absence |
| Example 4 | 90 | | 10 | | 20 | | 5 | 0.3 | 160 | A | absence | absence |
| Example 5 | 80 | | 20 | | 10 | | 5 | 0.5 | 180≤ | A | absence | absence |
| Example 6 | 80 | | 20 | | 30 | | 5 | 0.6 | 150 | A | absence | absence |
| Example 7 | 50 | | 50 | | 20 | | 5 | 1.2 | 170 | A | absence | absence |
| Example 8 | 20 | | 80 | | 20 | | 5 | 0.4 | 180≤ | B | absence | absence |
| Example 9 | 10 | | 90 | | 20 | | 5 | 0.3 | 180≤ | B | absence | absence |
| Example 10 | 80 | | | 20 | 20 | | 5 | 0.3 | 170 | A | absence | absence |
| Example 11 | 80 | | | 20 | 30 | | 5 | 0.3 | 160 | A | absence | absence |
| Example 12 | 50 | | | 50 | 20 | | 5 | 0.4 | 180≤ | A | absence | absence |
| Example 13 | 20 | | | 80 | 20 | | 5 | 0.2 | 180≤ | A | absence | absence |
| Example 14 | | | 22 | 78 | 2.2 | | 5 | 0.2 | 180≤ | B | absence | absence |
| Comparative | 80 | 20 | | | 10 | | 5 | 0.1 | 180≤ | A | absence | presence |
| Example 1 | | | | | | | | | | | | |
| Comparative | | 100 | | | 40 | 15 | 5 | 0.4 | 80 | B | presence | absence |
| Example 2 | | | | | | | | | | | | |
| Comparative | 100 | | | | 10 | | 5 | 0.1 | 100 | A | absence | presence |
| Example 3 | | | | | | | | | | | | |
| Comparative | | | 100 | | 20 | | 5 | 0.1 | 180≤ | C | absence | presence |
| Example 4 | | | | | | | | | | | | |

The numerical values for the synthetic resin, crosslinking agent, and filler in Table 2 represent the blended amounts (parts by mass).

As shown in the results in Table 2, the release films of Examples 1 to 14 had an Ra equal to or greater than that of the release film of Comparative Example 2 to which filler was added, and bad concave and the convex portions.

As shown in the results in Table 2, the release films of Examples 1 to 14 had better elongation than the release films of Comparative Examples 1 to 4, did not break at the release layer, and were also excellent in the evaluation of flow marks.

### EXPLANATION OF REFERENCES

10 Substrate layer
20 Release layer
30 Release film

1. A release film comprising a release layer and a substrate layer, wherein:
the release layer comprises two or more polymers, and
a difference in SP value between at least two of the polymers is 0.3 or more.

2. A release film comprising a release layer and a substrate layer, wherein:
the release layer comprises two or more polymers, and
at least one of the polymers is a nitrile group-containing (meth)acrylic polymer.

3. A release film comprising a release layer and a substrate layer, wherein:
the release layer comprises two or more polymers, and
at least one of the following (1) or (2) is satisfied:
(1) the release layer has a plurality of different regions with different component ratios, and in a case in which Raman spectroscopy is performed on the different regions, at least a part of the different regions exhibits different peak intensities, or
(2) a surface of the release layer has a convex portion and a concave portion, and in a case in which Raman spectroscopy is performed on the convex portion and the concave portion, at least a part of the convex portion and at least a part of the concave portion exhibits different peak intensities.

4. The release film according to claim 2, wherein a difference in SP value between at least two of the polymers is 0.3 or more.

5. The release film according to claim 1, wherein at least one of the polymers is a nitrile group-containing (meth)acrylic polymer.

6. The release film according to claim 1, wherein at least one of the following (1) or (2) is satisfied.
(1) the release layer has a plurality of different regions with different component ratios, and in a case in which Raman spectroscopy is performed on the different regions, at least a part of the different regions exhibit different peak intensities, or
(2) a surface of the release layer has a convex portion and a concave portion, and in a case in which Raman spectroscopy is performed on the convex portion and the concave portion, at least a part of the convex portion and at least a part of the concave portion exhibit different peak intensities.

7. The release film according to claim 3, wherein a component ratio of the polymers is different in at least a part of the plurality of different regions, or in at least a portion of the convex portion and at least a portion of the concave portion.

8. The release film according to claim 7, wherein a content of a nitrile group-containing (meth)acrylic polymer is different in at least a part of the plurality of different regions, or in at least a part of the convex portion and at least a portion of the concave portion.

9. The release film according to claim 3, wherein at least a part of the convex portion and the concave portion are formed by phase separation within the release layer.

10. The release film according to claim 3, wherein no interface is observed around the convex portion within the release layer under a laser microscope.

11. The release film according to claim 3, wherein peaks exhibiting different peak intensities are peaks derived from nitrile groups.

12. The release film according to claim 3, wherein the surface of the release layer has a convex portion and a concave portion, and a peak intensity derived from a nitrile group in at least a part of the convex portion is greater than a peak intensity derived from a nitrile group in at least a part of the concave portion.

13. The release film according to claim 3, wherein a surface of the release layer has a convex portion and a concave portion, and a content by mass of a nitrile group-containing (meth)acrylic polymer in at least a part of the convex portion is greater than a content by mass of a nitrile group-containing (meth)acrylic polymer in at least a part of the concave portion.

14. The release film according to claim 1, wherein an arithmetic mean roughness (Ra) of an outer surface of the release layer is 1.5 μm or less.

15. The release film according to claim 1, wherein a weight average molecular weight (Mw) of the polymers is 1.0×10⁵ or more.

16. The release film according to claim 1, wherein at least one of the polymers is a polymer containing a structural unit derived from a (meth)acrylonitrile monomer, and a difference in proportion of structural units derived from a (meth)acrylonitrile monomer between at least two of the polymers is 1% by mass or more.

17. The release film according to claim 1, wherein the two or more polymers are (meth)acrylic polymers having a structural unit derived from a (meth)acryloyl monomer.

18. The release film according to claim 1, wherein at least a portion of the polymer is crosslinked.

19. The release film according to claim 1, wherein a content of the polymer with a highest content in the release layer is 95% by mass or less with respect to a total content of the polymers.

20. The release film according to claim 1, wherein the substrate layer is a polyester film.

21. The release film according to claim 1, wherein a thickness of the release layer is from 1 μm to 50 μm.

22. The release film according to claim 1, which is a release film for a transfer mold or a release film for a compression mold.

23. A method of producing a semiconductor package, comprising:
carrying out a transfer molding process or a compression molding process using the release film according to claim 1.
